(19) United States
(12) Patent Application Publication
(10) Pub. No.: US 2026/0041125 A1
(43) Pub. Date: Feb. 12, 2026

(54) COMPOSITIONS AND METHODS FOR NON-ALCOHOLIC MIXED DRINKS

(71) Applicant: METHOD & MUSE SPIRITS, LLC, Golden, CO (US)

(72) Inventor: Ethan Tsai, Lafayette, CO (US)

(73) Assignee: METHOD & MUSE SPIRITS, LLC, Golden, CO (US)

(21) Appl. No.: 19/197,792

(22) Filed: May 2, 2025

Related U.S. Application Data
(60) Provisional application No. 63/681,456, filed on Aug. 9, 2024.

(51) Int. Cl. A23L 2/52; A23L 2/38; A23L 29/25

(52) U.S. Cl. CPC A23L 2/52; A23L 2/38; A23L 29/25

(57) ABSTRACT

Compositions and methods for producing low alcohol or non-alcoholic beverages containing hydrophobic or water immiscible compounds, where the low alcohol or non-alcoholic beverages have desirable organoleptic properties, including but not limited to taste, texture, color, and aroma. To incorporate the hydrophobic compounds into the composition, the composition is emulsified so that the hydrophobic fraction forms vesicles in a continuous phase formed by the water and a non-aqueous solvent. The emulsion has a low water content and serves a shelf stable concentrate, which can be mixed with water, tonic water, soda water, fruit juice, or combinations thereof, to form a beverage having similar taste to corresponding mixed drinks.

### CROSS-REFERENCE TO RELATED APPLICATIONS

This application claims priority from U.S. Provisional Patent Application No. 63/681,456, filed Aug. 9, 2024, which is incorporated by reference herein to the extent that there is no inconsistency with the present disclosure.

### FIELD OF THE DISCLOSURE

The present disclosure generally relates to compositions and methods for making alcohol-free or non-alcoholic beverages, particularly beverages that simulate the flavor of cocktails and mixed drinks.

### BACKGROUND OF THE INVENTION

An alcohol-free or non-alcoholic beverage is a version of an alcoholic drink made without alcohol (i.e., ethanol), or with the alcohol removed or reduced to almost zero. Such beverages may take the form of non-alcoholic mixed drinks, such as non-alcoholic cocktails, or non-alcoholic beer.

To produce an alcohol-free or non-alcoholic beverage, ethanol may be removed from a pre-existing alcoholic beverage, or the beverage may be made without incorporating ethanol to begin with. For example, different types of non-alcoholic cocktails have been developed containing a variety of fruit juices, syrups, herbs, spices, and/or soda water. However, these beverages typically have their own unique tastes and textures. It is often desirable to create non-alcoholic mixed drinks that provide the same, or very similar, tastes and organoleptic experiences as their alcoholic counterparts.

Vacuum distillation, reverse osmosis, and other techniques may be used to remove ethanol from pre-existing alcoholic drinks. However, typical techniques used to remove ethanol from existing alcoholic drinks also remove or degrade ingredients and compounds that provide the desired taste and feeling of alcoholic mixed drinks. Additionally, many ingredients and compounds that contribute to the taste of traditional alcoholic cocktails and other mixed drinks are highly soluble in ethanol but are hydrophobic or immiscible in water. Therefore, removing ethanol from an alcoholic mixed drink or attempting to make a mixed drink without adding ethanol will cause important ingredients and compounds to precipitate out of solution or result in these ingredients and compounds failing to solubilize into the final beverage.

Accordingly, what is needed are means for producing mixed drinks having low alcohol or reduced alcohol content while also having desirable taste, preferably where the low alcohol or reduced alcohol mixed drinks have comparable organoleptic properties as their alcoholic mixed drink counterparts. Also needed is a delivery system for quickly mixing and dispensing such mixed drinks.

### BRIEF SUMMARY OF THE INVENTION

The present invention provides compositions and methods for producing low alcohol or non-alcoholic beverages containing hydrophobic or water immiscible compounds, where the low alcohol or non-alcoholic beverages have desirable organoleptic properties, including but not limited to taste, texture, color, and aroma. Preferably, the composition has a low water content and serves as a shelf stable concentrate, which can be mixed with water, tonic water, soda water, fruit juice, or combinations thereof, to form a beverage having comparable organoleptic properties to the corresponding alcoholic beverage.

In an embodiment, the present invention provides a composition comprising: 40-50% by weight (wt %) of a non-aqueous solvent; 15-25 wt % of water; 20-30 wt % of a hydrophobic plant fraction comprising one or more phytochemicals; 5-15% wt % of an emulsifying agent or emulsion stabilizing agent; and 0-10 wt % of ethanol. Phytochemicals are organic and inorganic compounds produced by plants, and include herbs, spices, and other flavouring agents responsible for the taste of alcoholic beverages. Optionally, the one or more phytochemicals used in the composition are a lipid or oil obtained through an extraction process performed on a plant.

The plant fraction containing the one or more phytochemicals is hydrophobic and is immiscible with water. In an embodiment, the hydrophobic plant fraction further comprises lecithin, fruit powder, medium chain triglycerides, or combinations thereof, in addition to the one or more phytochemicals. Optionally, the hydrophobic plant fraction comprises dissolved fruit powder. In an embodiment, the hydrophobic plant fraction has a solubility with water less than 20 wt % (mass/mass percent), a solubility with water less than 15 wt %, a solubility with water less than 10 wt %, or a solubility with water less than 5 wt %. In an embodiment, the composition comprises 20-30 wt % of the hydrophobic plant fraction, 20-28 wt % of the hydrophobic plant fraction, 22-26 wt % of the hydrophobic plant fraction, 20-25 wt % of the hydrophobic plant fraction, or 22-25 wt % of the hydrophobic plant fraction.

To incorporate the hydrophobic plant fraction into the composition, the composition is emulsified so that the hydrophobic plant fraction forms vesicles in a continuous phase formed by the water and non-aqueous solvent. Preferably, in order to produce the desired texture and appearance of the resulting beverage, the composition is emulsified so as to produce very fine or small vesicles. In an embodiment, the composition is an emulsion having an average vesicle diameter less than 500 nm, an average vesicle diameter between 20 nm to 400 nm, an average vesicle diameter between 40 nm to 300 nm, an average vesicle diameter between 50 nm to 200 nm, an average vesicle diameter between 60 nm to 150 nm, or an average vesicle diameter between 60 to 100 nm.

The composition may be emulsified using any emulsifying or mixing technique known in the art able to produce the desired average vesicle size, including but not limited to high sheer homogenization and high pressure homogenization. In an embodiment, the components of the composition are emulsified using a high sheer mixer at 3,000 rpm or greater, 5,000 rpm or greater, 10,000 rpm or greater, 15,000 rpm or greater, or between 15,000 rpm and 20,000 rpm. In an embodiment, the components are mixed at high rpms for at least 3 minutes, at least 5 minutes, at least 10 minutes, at least 20 minutes, or between 5 minutes and 10 minutes. In an embodiment, the components of the composition are emulsified at a temperature between 10-60° C., between 15-45° C., between 18-30° C., between 20-40° C., between 20-30° C., or between 20-25° C.

The emulsifying agent or emulsion stabilizing agent is any surfactant or other molecule able to stabilize an emulsion or inhibit the immiscible liquids from separating into separate phases. Suitable emulsifying agents or emulsion stabilizing agents include, but not limited, to acacia gum, xanthan gum, lecithin, low molecular weight polyols, fruit powder, dextrin, maltodextrin, or combinations thereof. Low molecular weight polyols able to be used as an emulsifying agent or emulsion stabilizing agent in embodiments of the present invention include triethylene glycol (TEG), diethylene glycol (DEG), monoethylene glycol (MEG), polyethylene glycol (PEG), or combinations thereof. In an embodiment, the emulsifying agent or emulsion stabilizing agent is acacia gum and/or xanthan gum, preferably acacia gum. In an embodiment, the composition comprises 5-15 wt % of the emulsifying agent or emulsion stabilizing agent, 8-12 wt % of the emulsifying agent or emulsion stabilizing agent, or 8-10 wt % of the emulsifying agent or emulsion stabilizing agent.

Fruit powder is any solid in the form of small, loose particles made from a fruit as is known in the art, including, but not limited to, powders made by grinding, crushing, freeze drying, micronizing, or combinations thereof. In an embodiment, the fruit powder is made from a whole fruit, parts of the fruit, juice collected from a fruit, or a fruit extract. Optionally, fruit powder is used as part of the hydrophobic plant fraction, the emulsifying agent or emulsion stabilizing agent, or combinations thereof. In an embodiment, the fruit powder does not form part of the hydrophobic plant fraction. In another embodiment, the fruit powder does not form part of the emulsifying agent or emulsion stabilizing agent.

Optionally, the fruit powder is part of the hydrophobic plant fraction and is used as an additional sweetener or flavouring agent. In an embodiment, the fruit powder contains one or more short to medium chain sugars that are preferably non-digestible by bacteria, fungi, molds, and simple cell organisms. Such short to medium chain sugars are often used in food products as thickeners, binding agents, emulsifying agents, or emulsion stabilizing agents. Preferably, the fruit powder comprises dextrin, maltodextrin, or both, and is used to form part of the emulsifying agent or emulsion stabilizing agent.

The non-aqueous solvent may be any non-aqueous solvent that is safe for human consumption, including but not limited to food safe polyols. Preferably, the non-aqueous solvent is glycerol or a glycerol derivative, such as a glycerol ether. In an embodiment, the composition comprises 40-50 wt % glycerol, 42-48% glycerol, 43-47 wt % glycerol, or 44-46 wt % glycerol.

In an embodiment, the composition comprises small amounts of ethanol, such as less than 10 wt %, less than 8 wt %, less than 6 wt %, less than 4 wt %, less than 2 wt %, less than 1 wt %, less than 0.5 wt %, less than 0.05 wt %, or between 0 and 1 wt %. In an embodiment, the composition does not contain ethanol.

In an embodiment, the composition comprises 15-25 wt % water, 18-24 wt % water, or 20-23 wt % of water.

In an embodiment, the present invention provides a composition comprising: 43-47 wt % of the non-aqueous solvent; 20-23 wt % of water; 20-25% wt % of the hydrophobic plant fraction; 8-12% wt % of an emulsifying or emulsion stabilizing agent; and 0-2 wt % of ethanol, where the composition has an average vesicle diameter between 60 nm to 150 nm.

In an embodiment, the present invention provides a composition comprising: 43-47 wt % of glycerol; 20-23 wt % of water; 20-25% wt % of the hydrophobic plant fraction; 8-12% wt % of acacia gum and/or xanthan gum; and 0-2 wt % of ethanol, where the composition has an average vesicle diameter between 60 nm to 150 nm.

All of the components in the composition are preferably biocompatible and safe for human consumption, including substances that are Generally Regarded As Safe (GRAS) by the United States Food and Drug Administration. Additionally, the composition is preferably shelf stable with regard to the inactivation of bacterial growth. Typically, the ethanol in alcoholic drinks prevents or greatly reduces the presence of bacteria; however, the removal or absence of ethanol in non-alcoholic or alcohol-free beverages (in addition to not being able to dissolve hydrophobic compounds) allows bacteria to rapidly grow at room temperature. Bacterial growth can be reduced by reducing the water activity (aw) in the composition. Generally, foods with a water activity level of 0.85 or lower do not require refrigeration. In an embodiment, the compositions of the present invention have a water activity (aw) of less than 0.85, preferably less than 0.80, less than 0.70, preferably less than 0.65, or less than 0.6.

In an embodiment, the present invention provides a mixture comprising 0.5 g to 5.0 g of the composition and approximately 50 ml to 300 ml of a solution, where the solution and composition are mixed in order to form a consumable beverage. Preferably, the composition and solution are provided in amounts so that the resulting mixture forms a beverage having a flavor and texture similar to a predetermined alcoholic mixed drink. The solution may be any consumable liquid used in beverages, preferably aqueous solutions including but not limited to water, tonic water, soda water, fruit juice, or combinations thereof.

To form the beverage, preferably the composition is mixed with approximately 75 ml to 275 ml of the solution, 80 ml to 260 ml of the solution, 90 ml to 250 ml of the solution, 100 ml to 235 ml of the solution, 120 ml to 220 ml of the solution, 130 ml to 200 ml of the solution, or 150 ml to 180 ml of the solution. In an embodiment, the mixture comprises 0.5 g to 3.0 g of the composition, 0.5 g to 2.0 g of the composition, 1.0 g to 2.5 g of the composition, 1.0 g to 2.0 g of the composition, or 1.4 g to 1.6 g of the composition.

In an embodiment, the beverage is not a beer, non-alcoholic beer, or alcohol free beer. In an embodiment, the composition does not contain malt or hops.

The composition may be formed and stored separately from the solution used to make the beverage. Furthermore, different components of the composition may be formed and stored separately and then combined to form the composition, such as at the point of sale or where the beverage is served to customers. This may be beneficial in that commonly used ingredients, such as the beverage solution, may be produced in larger quantities and combined with less common ingredients for specific drinks on demand.

In an embodiment, the present invention provides a method for generating a non-alcoholic beverage comprising the steps of: a) providing a hydrophobic component comprising a plant lipid stock and a one or more phytochemicals; b) providing a second component comprising an emulsifying agent or emulsion stabilizing agent, water, and a non-aqueous solvent; and c) combining the hydrophobic component with the second component to form a combined mixture and emulsifying the combined mixture to form an emulsion having an average vesicle diameter less than 500 nm. Preferably, the emulsification step forms an emulsion having an average vesicle diameter between 20 nm to 400 nm, between 40 nm to 300 nm, between 50 nm to 200 nm, between 60 nm to 150 nm, or between 60 to 100 nm.

The formed emulsion may have the composition of any of the emulsions described above. For example, in an embodiment, the formed emulsion comprises: 40-50 wt % of the non-aqueous solvent; 15-25 wt % of water; 20-30 wt % of a hydrophobic plant fraction comprising the one or more phytochemicals, where the hydrophobic plant fraction has less than 20 wt % solubility with water; 5-15% wt % of the emulsifying agent or emulsion stabilizing agent; and 0-10 wt % of ethanol. In a further embodiment, the formed emulsion comprises: 43-47 wt % of the non-aqueous solvent; 20-23 wt % of water; 20-25% wt % of the hydrophobic plant fraction; 8-12% wt % of an emulsifying or emulsion stabilizing agent; and 0-2 wt % of ethanol. Preferably, the emulsion comprises less than 2 wt % of ethanol.

In an embodiment, the formed emulsion comprises: 43-47 wt % of glycerol; 20-23 wt % of water; 20-25% wt % of the hydrophobic plant fraction; 8-12% wt % of acacia gum and/or xanthan gum; and 0-2 wt % of ethanol. Preferably, the hydrophobic plant fraction has less than 10 wt % solubility with water.

Optionally, the one or more phytochemicals used in the composition are a lipid or oil obtained through an extraction process performed on a plant, where the extraction process includes, but is not limited to, a distillation, ethanol extraction, CO₂ extraction, or mash press performed on the plant. Optionally, the plant lipid stock comprises one or more lipids or oils extracted from a plant in addition to the one or more phytochemicals. The plant lipid stock may be able to be used as a common carrier or to aid the hydrophobic components to dissolve or mix together, and/or may be used as an additional flavoring agent. In an embodiment, the lipid stock comprises lecithin, fruit powder, medium chain triglycerides, or combinations thereof, in addition to the one or more phytochemicals.

In an embodiment, the hydrophobic component is formed separately from second component and stored for a period of at least two hours before mixing with the second component. Preferably, the hydrophobic component and the second component, independently from one another, have a stable shelf-life up to 6 months while still being able to be mixed with each other. In an embodiment, the hydrophobic component is stored for a period of 6 hours before mixing with the second component, stored for 12 hours, stored for 24 hours, stored for 2 days, stored for 7 days, stored for 14 days, stored for 20 days, stored for 30 days, stored for 60 days, stored for 120 days, stored 150 days, or stored for 180 days before mixing with the second component. In an embodiment, the second component is stored for a period of 6 hours before mixing with the second component, stored for 12 hours, stored for 24 hours, stored for 2 days, stored for 7 days, stored for 14 days, stored for 20 days, stored for 30 days, stored for 60 days, stored for 120 days, stored 150 days, or stored for 180 days before mixing.

In an embodiment, the method further comprises mixing the formed emulsion with an aqueous solution comprising water, tonic water, soda water, fruit juice, or combinations thereof, to form a beverage. Preferably, the emulsion is provided in an amount sufficient to form a beverage having a flavor and texture similar to a predetermined alcoholic mixed drink. In an embodiment, approximately 0.5 g to 3.0 g of the formed emulsion is added to approximately 50 ml to 300 ml of the solution.

In an embodiment, the beverage comprises approximately 0.1 wt % to 5 wt % of the emulsion, preferably 0.2 wt % to 4 wt %, 0.5 wt % to 2 wt %, 0.5 wt % to 1 wt %, or 0.6 wt % to 0.8 wt % of the emulsion.

In an embodiment, the formed emulsion is stored for a period of 6 hours before mixing with the aqueous solution to form the beverage, stored for 12 hours, stored for 24 hours, stored for 2 days, stored for 7 days, stored for 14 days, stored for 20 days, stored for 30 days, stored for 60 days, stored for 120 days, stored 150 days, or stored for 180 days before mixing with the aqueous solution.

The formed emulsion may be stored in one or more sealed packets or containers, wherein each sealed packet or container has approximately 0.5 g to 3 g of the emulsion, preferably 0.5 g to 2.0 g of the emulsion, 1.0 g to 2.5 g of the emulsion, 1.0 g to 2.0 g of the emulsion, or 1.4 g to 1.6 g of the emulsion. The method further comprises opening a selected sealed packet or container containing the emulsion, and mixing the emulsion with the solution to form the beverage. In an embodiment, each sealed packet or container contains approximately 0.5 g to 1 g of the emulsion, and wherein the emulsion from the sealed packet or container is mixed with approximately 100-200 ml of the solution.

Alternatively, the emulsion and the solution may be mixed using a dispenser, where the dispenser is in fluid communication with a reservoir containing the solution and is in fluid communication with a container containing the emulsion, and where the dispenser is able to administer approximately 0.5 g to 3 g of the emulsion to approximately 50 ml to 300 ml of the solution. Preferably, the dispenser is able to administer approximately 0.5 g to 1 g of the emulsion to approximately 100-200 ml of the solution. Optionally, the dispenser is preset to administer a selected amount of the emulsion to the solution.

In an embodiment, the dispenser is in fluid communication with multiple reservoirs or containers, where each container contains a different formed emulsion. For example, each container may contain a unique emulsion having a different flavor that is used to make a different beverage. Mixing the emulsion with the solution to form the beverage comprises selecting one of the different formed emulsions and using the dispenser to withdraw a selected amount of the selected emulsion and mixing the withdrawn amount of the selected emulsion with the solution. The amounts of each emulsion and the amount of the solution used, may differ for each beverage to be made.

### DETAILED DESCRIPTION OF THE INVENTION

### Definitions

“Alcohol by volume” (abbreviated as “alc/vol” or “ABV”) is a standard measure of the volume of alcohol contained in a given volume of an alcoholic beverage, expressed as a volume percent. It is defined as the number of millilitres (mL) of pure ethanol present in 100 mL of solution at 20° C.

The term “non-alcoholic” typically refers to beverages that contain 0.5% alcohol by volume (ABV) or less, while “alcohol-free” typically refers to beverages that contain 0.05% ABV or less.

As used herein, “organoleptic” refers to properties of a food or beverage that create an experience via the one of the senses, such as one or more of taste, color, appearance, aroma, and texture, and any combination thereof.

A “mixed drink” is a combination of one or more alcoholic spirits mixed with other ingredients, such as juices, flavored syrups, tonic or soda water, herbs, spices, and bitters.

“Phytochemicals” are organic and inorganic compounds produced by plants, typically through primary or secondary metabolism.

“Miscibility” refers to how substances, such as two liquids, combine or mix to form a homogenous solution. Immiscible substances do not form a homogenous solution and with immiscible liquids tend to form different layers or liquid phases. “Solubility” refers to the ability of a substance (the solute) to form a solution with another substance (the solvent), and is often expressed as the mass of solute per mass of solvent (g/g).

### Example 1—Generation of Shelf Stable Emulsion Composition

Ginger oleoresin, juniper berry oil, and medium chain triglyceride (MCT) oil were obtain from a commercial source. A lipid stock solution was formed by mixing 3.75 g of ginger oleoresin, 13.75 g of juniper berry oil, and 13.75 g of the MCT oil. To aid in mixing, the lipid stock solution may be heated while stirring, such as between 10-60° C., between 15-45° C., between 18-30° C., between 20-40° C., between 20-30° C., or between 20-25° C.

Various different plant extracts were obtained from a commercial source. These plant extracts include various herbs, spices, and other phytochemicals able to act as flavoring agents. The phytochemical extracts were combined as follows:

| | |
|---|---|
| Chamomile | 0.31 g |
| Coriander | 0.57 g |
| Peely | 0.31 g |
| Lime | 0.21 g |
| Juniper | 1.67 g |
| Allspice | 0.07 g |
| Hibiscus | 0.48 g |

These plant extracts were further combined with 0.03 g of sunflower lecithin and then added to 0.625 g of the lipid stock solution to form 4.275 g of a hydrophobic mixture.

A second mixture was separately formed as follows (all components obtained from commercial sources):

| | | |
|---|---|---|
| Water | 31.34 | g |
| Acacia gum | 12.5 | g |
| Ethanol | 2.31 | g |
| Glycerin | 63.8 | g |

4.275 g of the hydrophobic mixture was combined with 6.43 g of the second mixture (an approximate 40:60 mass ratio) and homogenized at 17,500 rpm for 5 minutes. The resulting emulsion remained stable for at least two weeks following formation. To form a non-alcoholic beverage, 220 ml of tonic water was mixed with 1.1 g of the emulsion, resulting in good sensory properties.

### Example 2—Increased Scale Experiment

A scaled up experiment was performed generally following the procedure from Example 1, but using the following amounts:

| | | |
|---|---|---|
| Chamomile | 3.7 | g |
| Coriander | 6.9 | g |
| Peely | 3.7 | g |
| Lime | 2.5 | g |
| Juniper | 20.1 | g |
| Allspice | 0.9 | g |
| Hibiscus | 5.8 | g |

These plant extracts were further combined with 0.4 g of sunflower lecithin and then added to 7.7 g of the lipid stock solution to form the hydrophobic mixture. The resulting hydrophobic mixture was mixed with 153.9 g of the second mixture and homogenized at 17,210 rpm for 5 minutes.

The resulting emulsion was also stable for at least several days and again produced a beverage having good flavor when mixed with tonic water.

### Example 3—Water Activity and Bacterial Growth and Inactivation

The shelf life for consumable food and beverage products is often determined by the structural stability of the product as well as the growth and inactivation of bacterial pathogens within the product. Bacterial growth is influenced by factors such as water activity (aw), acidity (pH), temperature, water phase salt, and oxygen requirements of the bacteria (see FDA Seafood HACCP Appendix 4: Bacterial Pathogen Growth and Inactivation, U.S. Food and Drug Administration).

Water activity is a measurement of the availability of water for biological reactions, and determines the ability of micro-organisms to grow. As known in the art and determined by the U.S. Food and Drug Administration, the water activity (aw) of a food is the ratio between the vapor pressure of the food itself, when in a completely undisturbed balance with the surrounding air media, and the vapor pressure of distilled water under identical conditions. A water activity of 0.80 means the vapor pressure is 80 percent of that of pure water.

Foods and beverages having a water activity above 0.95 will provide sufficient moisture to support the growth of bacteria, yeasts, and mold. However, by controlling the composition of the food product, the amount of available moisture can be reduced to a point which will inhibit the growth of micro-organisms. Generally, foods with a water activity level of 0.85 or lower do not require refrigeration.

The water activity was measured for the compositions generated according to Examples 1 and 2, and produced water activity measurements less than 0.6 aw, which means that the emulsion compositions of the present invention are shelf stable with regard to the inactivation of bacterial growth.

### Example 4—Phytochemical Extracts Created Through the Steam Extraction, Ethanolic Extraction, or CO₂ Extraction of Botanicals

Phytochemicals useful in the present invention include herbs, spices, and other flavouring agents responsible for the taste of alcoholic beverages. These hydrophobic compounds are often part of complex extractions from plants and are often easily damaged or lost when ethanol is removed from typical alcoholic beverages.

For example, ginger (Zingiber officinale) is a popular spice used globally. Chemical analysis of ginger shows that it contains over 400 different compounds. The major constituents of ginger rhizomes are carbohydrates (50-70%), lipids (3-8%), terpenes, and phenolic compounds, including zingiberene, β-bisabolene, α-farnesene, β-sesquiphellandrene, α-curcumene, gingerol, paradols, and shogaol (see Prasad et al., Gastroenterology Research and Practice 2015, 2015(1): 142979.

Commercially available ginger oleoresin contains about 60-80 compounds, many of which are not available individually because of the complexity required to identify and produce these compounds. The main component is zingerone which gives ginger its spicy character. Ginger also has citrus flavor caused by decanal, octanal, citral, and linalool, and has additional flavor notes contributed to by cis-3-hexenol, hexanal, borneol, and camphor.

Chamomile contains flavonoids, coumarins, volatile oils, terpenes, sterols, organic acids, and polysaccharides. A total of fifty flavonoids (having a core structure of 2-phenyl chromone) have been isolated from chamomile, including quercetin, apigenin, luteolin, and rutin, and are its main active components (see Dai et al., Molecules 2023, 28:133).

Allspice is obtained from the dried fruit of the Pimenta dioica plant has a flavor that is similar to the combination of cloves, nutmeg and cinnamon. Eugenol (60-90% in the berries, >90% in the leaves) is believed to be the key component followed by 1,8-cineole, α-humulene, and β-caryophyllene (see Rao et al., International Current Pharmaceutical Journal 2012, 1(8): 221-225).

Citrus peel is a by-product of citrus fruit processing. The main components of citrus peel essential oil include monoterpenes, sesquiterpenes and their oxygenated derivatives, with limonene, beta-pinene and linalool being major oil components in the peel of different citrus species (see Singh et al., Food Research International 12021, 43: 110231).

Coriander is an annual, herbaceous plant originating from the Mediterranean and Middle Eastern regions and contains monoterpenes, limpnene, a-pinene, g-terpinene, p-cymene, citronellol, borneol, camphor, coriandrin, geraniol, dihydrocoriandrin, coriandronsA-E, flavonoids and essential oils (see Nadeem et al., British Food Journal, 115(5): 743-755). Major compounds in coriander include linalool, a-pinene, g-terpinene, geranylacetate, camphor, and geraniol.

The proper blending of such phytochemical compounds, especially when the compounds are from multiple different plants, is necessary in order to produce high quality beverages, particularly those that produce similar taste and other qualities as known alcoholic drinks. The absence of one or more of these type of phytochemical compounds, or the addition of these compounds in an improper ratio, may result in a poor or unpleasant taste. Accordingly, the compounds and methods of present invention are beneficial in that they are able to incorporate such compounds, particularly those that are hydrophobic, in water based beverages without the use of ethanol or with very little ethanol.

Having now fully described the present invention in some detail by way of illustration and examples for purposes of clarity of understanding, it will be obvious to one of ordinary skill in the art that the same can be performed by modifying or changing the invention within a wide and equivalent range of conditions, formulations and other parameters without affecting the scope of the invention or any specific embodiment thereof, and that such modifications or changes are intended to be encompassed within the scope of the appended claims.

When a group of materials, compositions, components or compounds is disclosed herein, it is understood that all individual members of those groups and all subgroups thereof are disclosed separately. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. Additionally, the end points in a given range are to be included within the range. In the disclosure and the claims, “and/or” means additionally or alternatively. Moreover, any use of a term in the singular also encompasses plural forms.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements.

One of ordinary skill in the art will appreciate that starting materials, device elements, analytical methods, mixtures and combinations of components other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. The invention illustratively described herein suitably may be practiced in the absence of any element or elements, limitation or limitations which is not specifically disclosed herein. Headings are used herein for convenience only.

All publications referred to herein are incorporated herein to the extent not inconsistent herewith. Some references provided herein are incorporated by reference to provide details of additional uses of the invention. All patents and publications mentioned in the specification are indicative of the levels of skill of those skilled in the art to which the invention pertains. References cited herein are incorporated by reference herein in their entirety to indicate the state of the art as of their filing date and it is intended that this information can be employed herein, if needed, to exclude specific embodiments that are in the prior art.

1. A composition comprising:
40-50 wt % of a non-aqueous solvent;
15-25 wt % of water;
20-30 wt % of a hydrophobic plant fraction comprising one or more phytochemicals, wherein the hydrophobic plant fraction has less than 20 wt % solubility with water;
5-15% wt % of an emulsifying agent or emulsion stabilizing agent; and
0-10 wt % of ethanol,
wherein the composition is an emulsion having an average vesicle diameter between 20 nm to 400 nm.

2. The composition of claim 1, wherein the non-aqueous solvent is glycerol.

3. The composition of claim 1, wherein the hydrophobic plant fraction comprises lecithin, dissolved fruit powder, medium chain triglycerides, or combinations thereof, in addition to the one or more phytochemicals.

4. The composition of claim 1, wherein the hydrophobic plant fraction has less than 10 wt % solubility with water.

5. The composition of claim 1, wherein the emulsifying agent or emulsion stabilizing agent comprises acacia gum, xanthan gum, low molecular weight polyols, fruit powder, or combinations thereof.

6. The composition of claim 1, wherein the composition comprises less than 2 wt % of ethanol.

7. The composition of claim 1, wherein the composition has an average vesicle diameter between 60 nm to 150 nm.

8. The composition of any of claim 1, wherein the composition comprises:
43-47 wt % of glycerol;
20-23 wt % of water;
20-25% wt % of the hydrophobic plant fraction;
8-12% wt % of acacia gum and/or xanthan gum; and
0-2 wt % of ethanol,
wherein the composition has an average vesicle diameter between 60 nm to 150 nm, and has a water activity (aw) of less than 0.6.

9. A mixture comprising approximately 0.5 g to 3.0 g of the composition of claim 1 and approximately 50 ml to 300 ml of a solution comprising water, tonic water, soda water, fruit juice, or combinations thereof, wherein the solution and composition are mixed in order to form a consumable beverage.

10. The mixture of claim 9, wherein the composition is provided in an amount to form a beverage having a flavor and texture similar to a predetermined alcoholic mixed drink, wherein the mixture is not a beer or non-alcoholic beer.

11. A method of generating a non-alcoholic beverage comprising the steps of:
a) providing a hydrophobic component comprising a plant lipid stock and one or more phytochemicals;
b) providing a second component comprising an emulsifying agent or emulsion stabilizing agent, water, and a non-aqueous solvent; and
c) combining the hydrophobic component with the second component to form a combined mixture and emulsifying the combined mixture to form an emulsion comprising:
40-50 wt % of the non-aqueous solvent;
15-25 wt % of water;
20-30 wt % of a hydrophobic plant fraction comprising the one or more phytochemicals, wherein the hydrophobic plant fraction has less than 20 wt % miscibility with water;
5-15% wt % of the emulsifying agent or emulsion stabilizing agent; and
0-10 wt % of ethanol, and
wherein the emulsion has an average vesicle diameter less than 500 nm.

12. The method of claim 11 further comprising generating the one or more phytochemicals by performing an extraction on a plant.

13. The method of claim 11 comprising storing the hydrophobic component separately from the second component for a period of at least two hours.

14. The method of claim 13 wherein the hydrophobic component and the second component, independently form one another, have a storage life of at least 30 days.

15. The method of claim 11, wherein the hydrophobic plant fraction has less than 10 wt % solubility with water.

16. The method of claim 11, wherein the emulsion comprises less than 2 wt % of ethanol.

17. The method of claim 11, wherein the emulsion comprises:
43-47 wt % of glycerol;
20-23 wt % of water;
20-25% wt % of the hydrophobic plant fraction;
8-12% wt % of acacia gum and/or xanthan gum; and
0-2 wt % of ethanol,
wherein the emulsion has an average vesicle diameter between 60 nm to 150 nm.

18. The method of claim 11 comprising mixing the emulsion with approximately 50 ml to 300 ml of a solution comprising water, tonic water, soda water, fruit juice, or combinations thereof, to form a beverage, wherein the emulsion is provided in an amount to form a beverage, wherein the emulsion comprises approximately 0.5 wt % to 1 wt % of the beverage.

19. The method of claim 18 comprising storing the emulsion in one or more sealed packets or containers, wherein each sealed packet or container has approximately 0.5 g to 3 g of the emulsion; opening a selected sealed packet or container containing the emulsion, and mixing the emulsion with the solution to form the beverage, wherein each sealed packet or container contains approximately 0.5 g to 1 g of the emulsion, and wherein the emulsion from the sealed packet or container is mixed with approximately 200 ml of the solution.

20. The method of claim 18 comprising mixing the emulsion and the solution using a dispenser, wherein the dispenser is in fluid communication with a reservoir containing the solution and is in fluid communication with a container containing the emulsion, and wherein the dispenser administers approximately 0.5 g to 3 g of the emulsion to approximately 50 ml to 300 ml of the solution.

21. The method of claim 20, wherein the dispenser is in fluid communication with two or more containers, where each container contains a different formed emulsion and mixing the emulsion with the solution comprises selecting one of the different formed emulsions and mixing the selected emulsion with the solution.
